(19) United States
(12) Patent Application Publication
(10) Pub. No.: US 2002/0162112 A1
(43) Pub. Date: Oct. 31, 2002

(54) PC-based virtual set-top box for internet-based distribution of video and other data

(75) Inventor: Shoeb M. Javed, Plano, TX (US)

Correspondence Address: Docket Clerk, P.O. Drawer 800889, Dallas, TX, 75380, US

(73) Assignee: VESTA BROADBAND SERVICES, INC., McKinney, TX (US)

(21) Appl. No.: 10/081,867

(22) Filed: Feb. 20, 2002

Related U.S. Application Data
(60) Provisional application No. 60/270,498, filed on Feb. 21, 2001.

(51) Int. Cl. H04N 7/173; H04N 5/445

(52) U.S. Cl. 725/87; 725/110; 725/134; 725/37

(57) ABSTRACT

For use in connection with a communication network that communicates with a plurality of video content servers storing a plurality of video files for download to a subscriber, a network video player for downloading a first selected one of the plurality of video files. The network video player comprises: 1) a browser program stored on a computer-readable storage medium capable of being executed by a processing system comprising a central processing unit (CPU) and a memory; and 2) a video download control program stored on the computer-readable storage medium capable of being executed by the processing system. The browser program and the video download control program transmit video outputs and audio outputs to a television set via a wireless transceiver system coupled to the processing system and receive via the wireless transceiver system user commands and user data transmitted by a viewer control device operated by a viewer of the television set. The received user commands and user data are used by the browser program and the video download control program to browse the plurality of video content servers and to download the first selected video file.

### TECHNICAL FIELD OF THE INVENTION

The present invention relates generally to systems and methods for the distribution of video files via a public communications network and, more particularly, to network video player that may be connected to a television set and used to rent and to download video files and other data files distributed via an Internet protocol (IP) network.

### BACKGROUND OF THE INVENTION

Every year millions of consumers rent videos from video rental stores such as BLOCKBUSTER®. Video stores provide videos on video cassette recorder (VCR) tapes and on digital versatile disks (DVDs). One of the attractive features of renting or buying a video is that is offers a person an opportunity to shop for a wide variety of movies, including recent studio releases and older movies that have been out of theaters for a long time. The attractive movie box covers displayed on shelves in a video store serve to remind shoppers of movies they may have missed when the movies were still in theaters. The box covers also introduce shoppers to movies with which they are unfamiliar.

Another attractive feature of renting or buying a video is that it provides a person with the convenience of watching a particular movie when the person wants to watch the movie. Thus, the consumer does not have to wait for the movie to be broadcast again in order to view it. Furthermore, if a person rents or buys a video, he or she does not have to watch commercials and does not have to watch the entire movie in one sitting, but may pause the video at his or her convenience. The conveniences of buying or renting a video are particularly important to a consumer whose infrequent television viewing habits do not just justify the cost of paying for premium movie channels, such as HBO® or SHOWTIME®.

Unfortunately there are numerous inconveniences associated with buying or renting videos from a video store. Every video rental involves the inconvenience of two trips to the video store: one trip to rent the video and one trip to return the video. If the consumer is not able to return the video to the video store by the return deadline, the consumer must pay a daily late fee that frequently is larger than the original daily rental fee. In fact, a significant portion of the revenues of many video stores come from late fees. Many consumers would prefer not to go out in bad weather to rent a video or, more importantly, to return a video.

Therefore, there is a need for automated systems and methods for previewing and renting (or purchasing) videos over a common communication network that a consumer may easily access. In particular, there is a need in the art for an Internet-based video distribution system that allows a consumer to preview and to rent (or purchase) a video online and to download the rented or purchased video to a network video player in the consumer's home or office.

One possible solution for a network video player is a conventional set-top box (STB), such as the kind use by cable television companies. Once a set-top box is connected to the internet with a broadband connection, a viewer could then exploit features that are controllable from the TV, such as web browsing, email, video email, interactive advertising, games, and the like. These services are controlled by a viewer using a remote control from the comfort of the living room.

However, the main drawback of a set-top box is that the end user has to buy another expensive device in addition to his or her personal computer (PC) to access these features from their TV. The consumer may also have to get additional networking equipment to connect the set-top box to a single internet connection. Most (if not all) people that have broadband internet access already have a PC which has all the hardware required to support the set-top box features mentioned above. Therefore, there is a need for a PC-based virtual set-top box that enables a TV viewer to browse the Internet while watching television and to rent and to download video data files (or other data files, such as MP3 music files) via the television set.

### SUMMARY OF THE INVENTION

To address the above-discussed deficiencies of the prior art, it is a primary object of the present invention to provide, for use in connection with a communication network capable of communicating with a plurality of video content servers storing a plurality of video files for download to a subscriber, an apparatus for downloading a first selected one of the plurality of video files. According to an advantageous embodiment of the present invention, the apparatus comprises: 1) a processing system comprising a central processing unit (CPU) and a memory capable of executing a browser program and a video download control program; and 2) a first wireless transceiver system capable of being coupled to the processing system and capable of transmitting video outputs and audio outputs generated by the browser program and the video download control program to a television set apart from the processing system and further capable of receiving user commands and user data transmitted by a viewer control device operated by a viewer of the television set, wherein the received user commands and user data are used by the browser program and the video download control program to browse the plurality of video content servers and to download the first selected video file.

According to the advantageous embodiment, the apparatus further comprises: 3) a second wireless transceiver system capable of being coupled to the television set and capable of receiving video outputs and audio outputs transmitted by the processing system and displaying the received video outputs and audio outputs on the television set, wherein the wireless transceiver system is further capable of receiving user commands and user data transmitted by the viewer control device and transmitting the received user commands and user data to the processing system.

It is a primary object of the present invention to provide, for use in connection with a communication network capable of communicating with a plurality of video content servers storing a plurality of video files for download to a subscriber, a network video player for downloading a first selected one of the plurality of video files. According to an advantageous embodiment of the present invention, the network video player comprises: 1) a browser program stored on a computer-readable storage medium capable of being executed by a processing system comprising a central processing unit (CPU) and a memory; and 2) a video download control program stored on the computer-readable storage medium capable of being executed by the processing system, wherein the browser program and the video download control program are capable of transmitting video outputs and audio outputs generated by the browser program and the video download control program to a television set via a wireless transceiver system coupled to the processing system and are further capable of receiving via the wireless transceiver system user commands and user data transmitted by a viewer control device operated by a viewer of the television set, wherein the received user commands and user data are used by the browser program and the video download control program to browse the plurality of video content servers and to download the first selected video file.

According to one embodiment of the present invention, the browser program is capable of accessing the video content servers and retrieving therefrom web page data associated with the plurality of video files and displaying the web page data on the television set.

According to another embodiment of the present invention, the video download control program, in response to a first user command from the viewer requesting a first selected one of the plurality of video files, downloads the first selected video file from a first one of the plurality of video content servers.

According to still another embodiment of the present invention, the processing system further comprises a mass storage medium capable of storing the downloaded first selected video file.

According to yet another embodiment of the present invention, the browser program is capable of displaying on the television a plurality of video selection menus associated with the web page data, a first one of the video selection menus containing a first menu option associated with the first selected video file, wherein the video download control program is further capable of receiving from the viewer a first video selection command selecting the first selected video file to be downloaded.

According to a further embodiment of the present invention, the video download control program, in response to receipt of the first video selection message, transmits to the first video content server a video request message comprising a subscriber identifier associated with the video download control program, the video request message capable of causing the first video content server to transmit the first selected video file to the processing system when the video download control program subsequently transmits the subscriber identifier to the first video content server.

According to a still further embodiment of the present invention, the video request message further comprises a video identifier associated with the first selected video file, wherein the first video content server uses the video identifier to select the first selected video file from the plurality of video files for transmission to the processing system.

Before undertaking the DETAILED DESCRIPTION OF THE INVENTION, it may be advantageous to set forth definitions of certain words and phrases used throughout this patent document: the terms “include” and “comprise” and their derivatives mean inclusion without limitation; the term “or” is inclusive, meaning and/or; the term “associable” and the phrases “associated with” and “associated therewith” and their derivatives thereof may mean to include, be included within, interconnect with, contain, be contained within, connect to or with, coupled to or with, be communicable with, cooperate with, interleave, juxtapose, be proximate to, be bound to or with, have, have a property of, or the like; and the term “controller” means any device, system or part thereof that controls at least one operation. Such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a block diagram of an exemplary automated video distribution system according to one embodiment of the present invention;

FIG. 2 is a more detailed block diagram of selected portions of the exemplary automated video distribution system according to one embodiment of the present invention;

FIG. 3 is a message flow diagram illustrating an exemplary end-to-end video rental or sale transaction between an exemplary network video player (NVP), an exemplary video Internet service provider (VISP) network and an exemplary video point-of-presence (VPOP) network according to one embodiment of the present invention;

FIG. 4 is a message flow diagram illustrating an exemplary process of viewing a video already rented by the subscriber according to one embodiment of the present invention;

FIG. 5 is a message flow diagram illustrating an exemplary process of extending the rental duration for a video already downloaded to an exemplary NVP according to one embodiment of the present invention;

FIG. 6 illustrates an exemplary header that may be attached to video files downloaded to an NVP according to one embodiment of the present invention;

FIG. 7 illustrates an exemplary header that may be attached to video files stored on a VPOP network according to one embodiment of the present invention;

FIG. 8 illustrates an exemplary header that may be attached to records in the VPOP database for each copy of a video rented according to one embodiment of the present invention;

FIG. 9 illustrates an exemplary web page from which a subscriber using the exemplary network video player may select a video to rent or to purchase, according to one embodiment of the present invention;

FIG. 10 illustrates an exemplary web page from which a subscriber may learn additional details concerning a selected video, according to one embodiment of the present invention;

FIG. 11 is a more detailed block diagram of selected portions of the exemplary network video player according to one embodiment of the present invention;

FIG. 12 is a flow chart illustrating the operation of the exemplary network video player according to one embodiment of the present invention;

FIGS. 13A and 13B illustrate an exemplary PC-based network video player according to an alternate embodiment of the present invention; and

FIG. 14 is a flow diagram illustrating the operation of the exemplary PC-based network video player according to an alternate embodiment of the present invention.

### DETAILED DESCRIPTION OF INVENTION

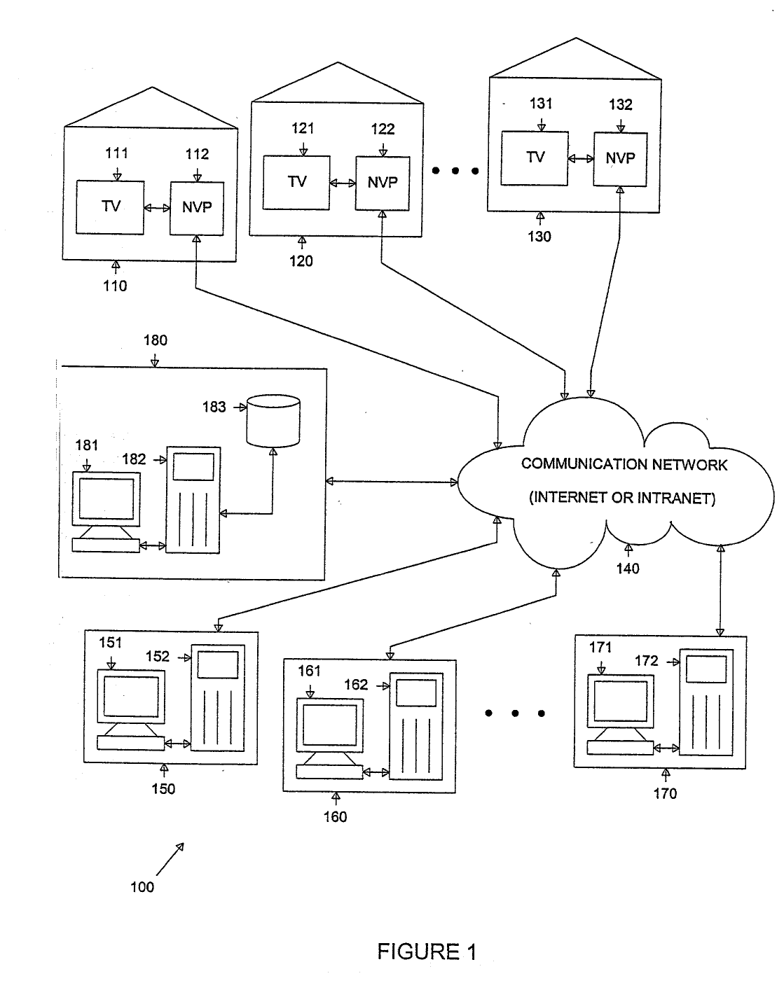

FIGS. 1 through 14, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged data network.

FIG. 1 is a block diagram of automated video distribution system 100 according to one embodiment of the present invention. Automated video distribution system 100 comprises a group of “M” subscriber sites (typically homes), including exemplary subscriber sites 110, 120, and 130, and a group of “N” video point-of-presence (VPOP) networks, including exemplary VPOP network 150, VPOP network 160, and VPOP network 170. Automated video distribution system 100 also comprises video Internet service provider (VISP) network 180. The subscriber sites, VPOP networks, and VISP network 180 communicate over common communication network 140, which is an Internet protocol (IP) based network, such as the Internet or one or more privately owned IP-based intranets.

Exemplary subscriber site 110 comprises television set 111 and exemplary network video player (NVP) 112 according to the principles of the present invention. Similarly, exemplary subscriber site 120 comprises television set 121 and exemplary network video player (NVP) 122 and exemplary subscriber site 130 comprises television set 131 and exemplary network video player (NVP) 132. As will be described below in greater detail, subscribers use NVP 112, NVP 122 and NVP 132 to access VISP network 180 in order to rent or purchase videos that are stored on one or more of VPOP network 150, VPOP network 160 and VPOP network 170. One or more of NVP 112, NVP 122 and NVP 132 may be implemented as a stand-alone device, such as a set top box or a personal computer, attached to a corresponding one of television sets 111, 121 and 131. Alternatively, one or more of NVP 112, NVP 122 and NVP 132 may be integrated into a corresponding one of television sets 111, 121 and 131.

Exemplary VPOP network 150 may comprise one or more workstations, collectively represented by workstation 151, and one or more video access servers, collectively represented by VPOP server 152. Similarly, exemplary VPOP network 160 may comprise one or more workstations, collectively represented by workstation 161, and one or more video access servers, collectively represented by video access server 162. Finally, exemplary VPOP network 170 may comprise one or more workstations, collectively represented by workstation 171, and one or more video access servers, collectively represented by video access server 172. As will be explained below in greater detail, each of VPOP networks 150, 160 and 170 allows subscribers previously authenticated and authorized by VISP network 180 to access and download video files.

Finally, VISP network 180 comprises one or more workstations, collectively represented by workstation 181, one or more servers, collectively represented by VISP server 182, and one or more database storage devices, collectively represented by VISP database 183. Among other things, VISP server 182 acts as a broker between a subscriber that wishes to download a selected video and a VPOP that has the selected video file.

It should be understood that the above-described embodiments of subscriber sites 110, 120, and 130, VPOP networks 150, 160, and 170, and VISP network 180 are illustrative only and that other architectures may be employed that do not depart from the spirit and scope of the invention. For example, in some embodiments of the present invention, one or more of NVP 112, NVP 122 and NVP 132, and VPOP networks 150, 160, and 170 may comprise a single desktop personal computer (PC) coupled to the Internet that provides a single subscriber with access to VISP network 180. In some embodiments of the present invention, one or more of NVP 112, NVP 122 and NVP 132 may be a laptop computer that is capable of accessing the Internet (i.e., common communication network 140) via a wireless modem. Similarly, one or more of VPOP networks 150, 160, and 170 may be connected wirelessly to communication network 140, such as by a satellite link.

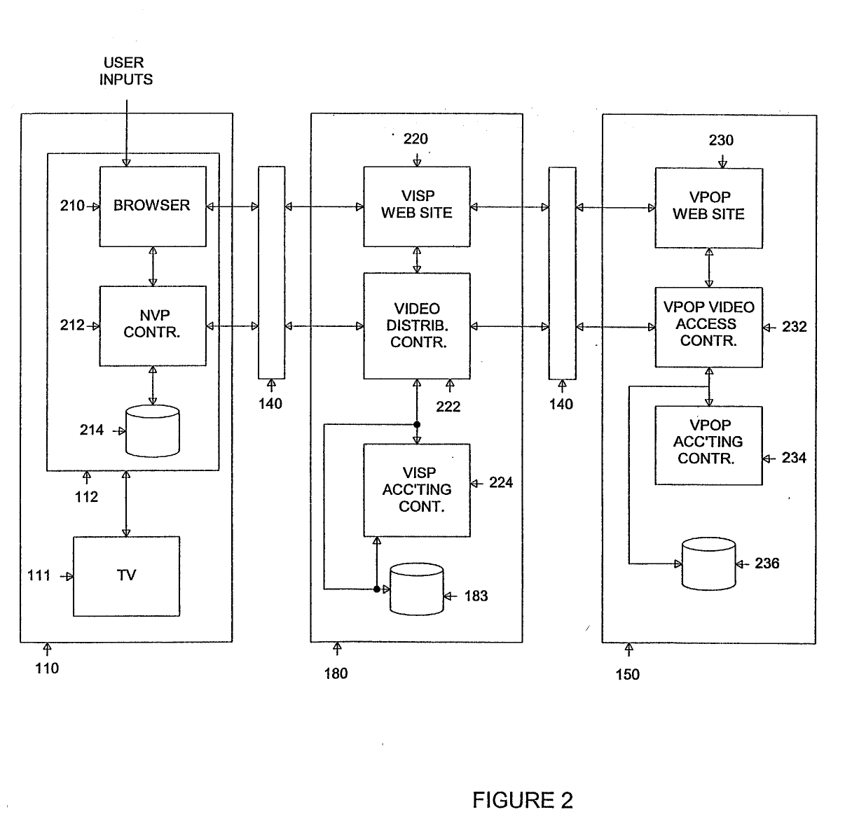

FIG. 2 is a more detailed block diagram of selected portions of automated video distribution system 100 according to one embodiment of the present invention. In particular, FIG. 2 illustrates selected portions of subscriber site 110, VPOP network 150, VISP network 180 and common communication network 140. Network video player (NVP) 110 in subscriber site 110 comprises browser software application 210 (hereafter, simply “browser 210”), NVP controller 212, and NVP storage device 214 (typically a disk drive, which stores downloaded videos. VPOP network 150 comprises VPOP web site software application 230 (hereafter, simply “VPOP web site 230”), VPOP video access controller 232, VPOP accounting controller 234, and VPOP database 236. Finally, VISP network 180 comprises VISP web site software application 220 (hereafter, simply “VISP web site 220”), video distribution controller 222, VISP accounting controller 224, and VISP database 183.

The term “controller” as used with respect to the items in FIG. 2 is broadly defined and may mean any device, system or part thereof that controls at least one operation. Such a device may be implemented in hardware or software, or a combination of hardware and software. Furthermore, the functionality associated with any particular controller may be centralized or distributed, whether locally or remotely. A controller may comprise one or more data processors, and associated input/output devices and memory, that execute one or more application programs and/or an operating system program.

In particular, NVP controller 212 may comprise software applications executed by the central processing unit (CPU) in NVP 112, which may also execute browser 210. Likewise, VPOP video access controller 232 and VPOP accounting controller 234 may comprise software applications executed by the central processing unit (CPU) in VPOP server 152. VPOP server 152 may also execute VPOP web site 230. Finally, video distribution controller 222 VISP accounting controller 224 may comprise software applications executed by the central processing unit (CPU) in VISP server 182. VISP server 182 may also execute VISP web site 220.

When the subscriber of subscriber site 110 first rents or buys a video file via VISP network 180, NVP controller 212, which may work in cooperation with browser 210, gathers initial setup data from the subscriber, such as a personal name, credit card number, address information, and the like, and transfer this information to VISP accounting controller 224. If the subscriber at subscriber site 110 has previously used VISP network 180, a user name and password prompt may be used to quickly identify the subscriber and retrieve previously stored information from VISP database 183. Thus, NVP controller 212 and VISP accounting controller 224 may be used to gather details about particular subscribers that have previously used VISP network 180 and also may be used to gather information from new subscribers that are using VISP network 180 for the first time.

When a subscriber wishes to buy or rent a video, the subscriber browses VISP web site 220, which is capable of accessing VPOP web site 230 and other VPOP web sites in order to retrieve video files and related identification information stored on VPOP database 236. Video distribution controller 222 guides the subscriber through a sequence of web site menus from which the subscriber may select a video. Video distribution controller 222 transfers information related to the selected video to VPOP video access controller 232 that allows the subscriber to subsequently communicate with VPOP video access controller 232 in order to download the selected video via communication network 140. After the subscriber has selected a video to download, NVP controller 212 communicates with VPOP video access controller 232 to actually download the selected video file. Payment for the rented or purchased video and related invoicing information is then transferred from VISP accounting controller 224 to VPOP accounting controller 234.

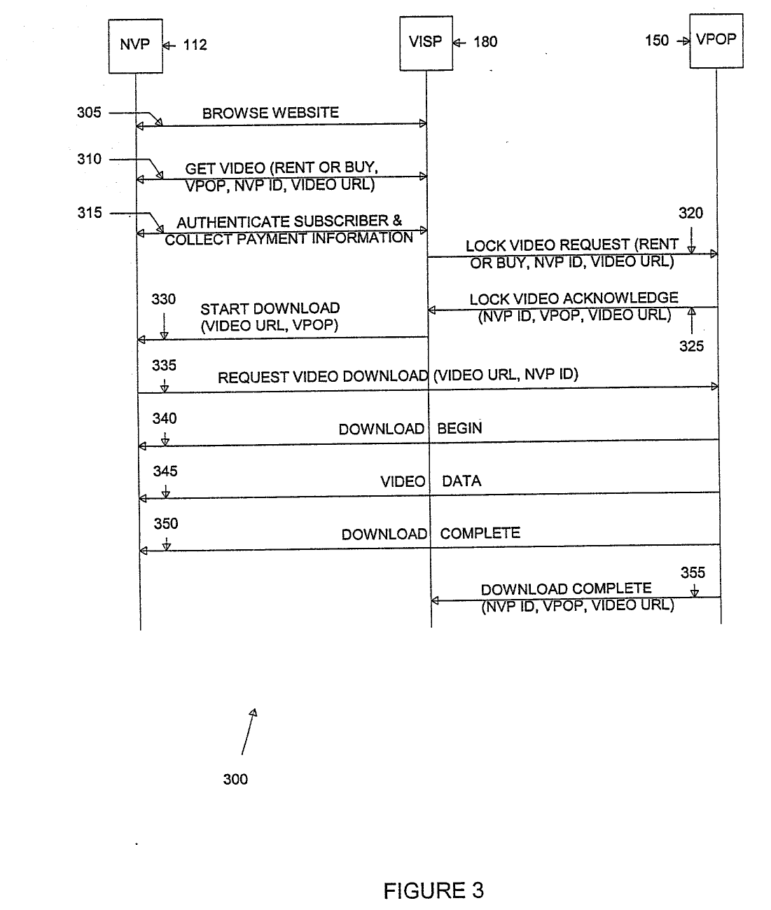

FIG. 3 depicts message flow diagram 300, which illustrates an exemplary end-to-end video rental or sale transaction between NVP 112, VISP network 180 and VPOP network 150 according to one embodiment of the present invention. Initially, a subscriber using NVP 112 changes to the video services channel on television 111. The process of changing to the video services channel initiates an IP connection between NVP 112 and VISP network 180. At this point, VISP web site 220 at VISP network 180 appears on the screen of television 111. The subscriber uses the TV remote control, wireless keyboard or a pointing device, such as a mouse coupled to NVP 112, to browse VISP web site 220 to select the video content that he or she prefers to buy, rent or otherwise acquire. A variety of selection criteria may be used to select the video content. VISP network 180 then displays a list of VPOPs, including VPOP network 150, offering the video content selected by the subscriber. The subscriber then chooses a VPOP from which to buy or rent the video content. The VPOP selection criteria may be determined by geographical location (quicker downloads), cost of the video content, and any other differentiator, whether based on technological constraints, economic issue, or any other related resource allocation issues, that the VPOPs use to attract and retain customers. The subscriber also chooses whether the video content is to be rented or purchased, and if rented, the duration of the rental (process step 305).

Once the video content and VPOP selection is made, VISP network 180 authenticates the subscriber (possibly using subscriber account number, password, and the like) and collects payment information (credit card, add to cable bill, and the like) (process step 310). VISP network 180 then asks VPOP network 150 to reserve a copy of the video content (Lock Video Request) requested by the subscriber by sending VPOP network 150 the subscriber's unique NVP ID. The NVP ID is a code embedded in NVP 112. VISP network 180 also informs VPOP network 150 whether the video content is to be rented or purchased by the subscriber, and if rented, the rental duration (process step 315).

VPOP network 150 responds by reserving a copy of the video content rented or purchased by the subscriber and sends a positive acknowledgment (Lock Video Acknowledgment) to VISP network 180. VISP network 180 creates a billing record with the subscriber's account information and NVP ID for the video content rented or purchased (process step 320). VISP network 180 then sends a positive acknowledgment to NVP 112 to begin downloading the video content from VPOP network 150 (process step 330).

Next, NVP 112 connects to VPOP network 150 and provides information (Video URL) identifying the movie to be purchased or rented as well as the unique NVP ID of NVP 112 (process step 335). VPOP network 150 verifies that a record exists for the NVP ID and the video content requested by NVP 112. VPOP network 150 then downloads a file containing the requested video content to NVP 112 (process steps 340, 345 and 350). After the download is complete, VPOP network 150 informs VISP network 180 that the download is complete, providing VISP network 180 with the subscriber's NVP ID as well as identifying the video content rented or purchased. VISP network 180 then completes and closes the billing record created for the subscriber using NVP 112 (process step 355).

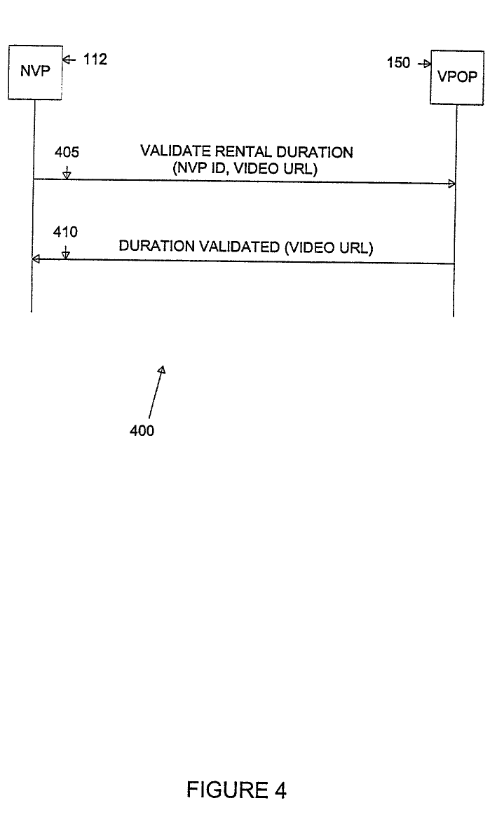

FIG. 4 depicts message flow diagram 400, which illustrates an exemplary process of viewing a video already rented by the subscriber according to one embodiment of the present invention. Initially, the subscriber, using the remote control of television 111 or a pointing device coupled to NVP 112, selects and plays the rented video. NVP 112 connects to VPOP network 150 from which the video was rented and requests VPOP network 150 to verify that the rental duration for the video is still current. NVP 112 provides VPOP network 150 the video URL as well as the unique NVP ID of NVP 112 (process step 405). VPOP network 150 locates the rental record for the NVP ID and video URL sent by NVP 112. VPOP network 150 compares the time-stamp on the rental record with the current time to see if the video is within the rental duration paid for by the subscriber. If the video is still within the rental duration paid for by the subscriber, VPOP network 150 sends an acknowledgment to NVP 112 that the video may be viewed by the subscriber (process step 410). NVP 112 then plays the video on television 111.

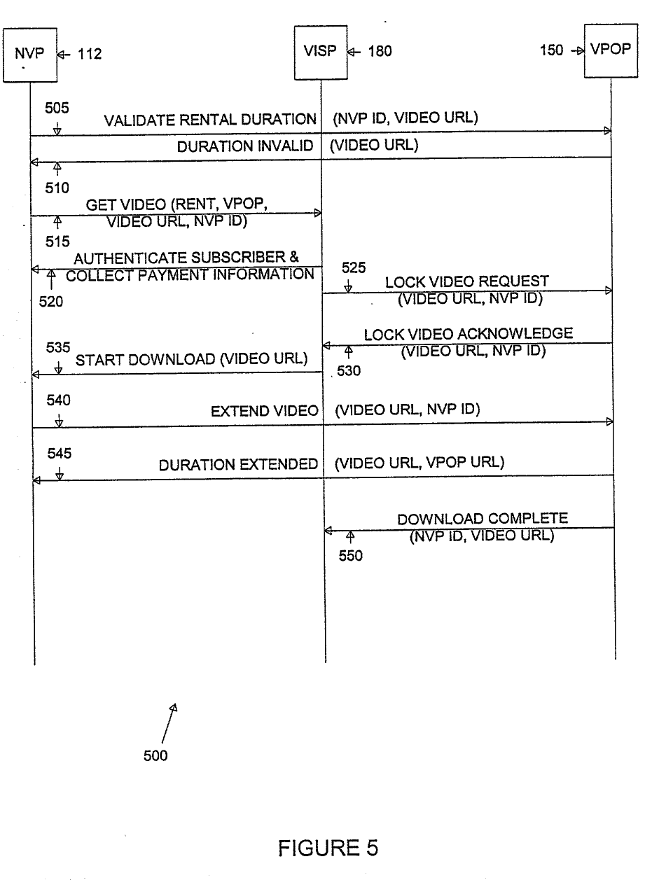

FIG. 5 depicts message flow diagram 500, which illustrates an exemplary process of extending the rental duration for a video already downloaded to NVP 112 according to one embodiment of the present invention. Initially, the subscriber, using the remote control of television 111 or a pointing device coupled to NVP 112, selects and plays the rented video. NVP 112 connects to VPOP network 150 from which the video was rented and requests VPOP network 150 to verify that the rental duration for the video is still current. NVP 112 provides VPOP network 150 the video URL as well as the NVP ID of NVP 112 (process step 505). VPOP network 150 locates the rental record for the NVP ID and video URL sent by NVP 112. VPOP network 150 compares the time-stamp on the rental record with the current time to see if the video is within the rental duration paid for by the subscriber. VPOP network 150 determines that the rental period on the video requested by NVP 112 has expired and sends a negative acknowledgment back to NVP 112 (process step 510).

Next, NVP 112 prompts the subscriber to extend the rental duration and the subscriber elects to extend the rental duration for the video to be viewed. NVP 112 connects to VISP network 180 and sends a rental request providing VISP network 180 with the unique NVP ID of NVP 112, the video URL and VPOP network 150 information (process step 515). VISP network 180 then authenticates the subscriber and collects payment information (process step 520).

Once payment is collected, VISP network 180 requests VPOP network 150 to reserve a copy of the video content requested by the subscriber by sending VPOP network 150 the unique NVP ID of NVP 112. VISP network 180 also informs VPOP network 150 of the rental duration (process step 525). VPOP network 150 responds by reserving a copy of the video content rented by the subscriber and sends a positive acknowledgment to VISP network 180. In response, VISP network 180 creates a billing record with the subscriber's account information and the NVP ID of NVP 112 for the video content rented (process step 530).

VISP network 180 sends a positive acknowledgment to NVP 112 to begin downloading the video content from VPOP network 150 (process step 535). NVP 112 connects to VPOP network 150 and requests that the rental duration for the video be extended, providing VPOP network 150 with the corresponding video URL and the NVP ID of NVP 112 (process step 540). VPOP network 150 verifies that a record exists for the NVP ID of NVP 112 for the video content requested by NVP 112. VPOP network 150 then downloads a new header to NVP 112 with the rental extension information (process step 545). VPOP network 150 informs VISP network 180 that the download is complete, providing VISP network 180 with the NVP ID of NVP 112 as well as the video content rented. VISP network 180 then completes and closes the billing record for the subscriber (process step 550).

To carry out the exemplary transactions described above, each of the network components implementing the video network may carry out various processes that are described below.

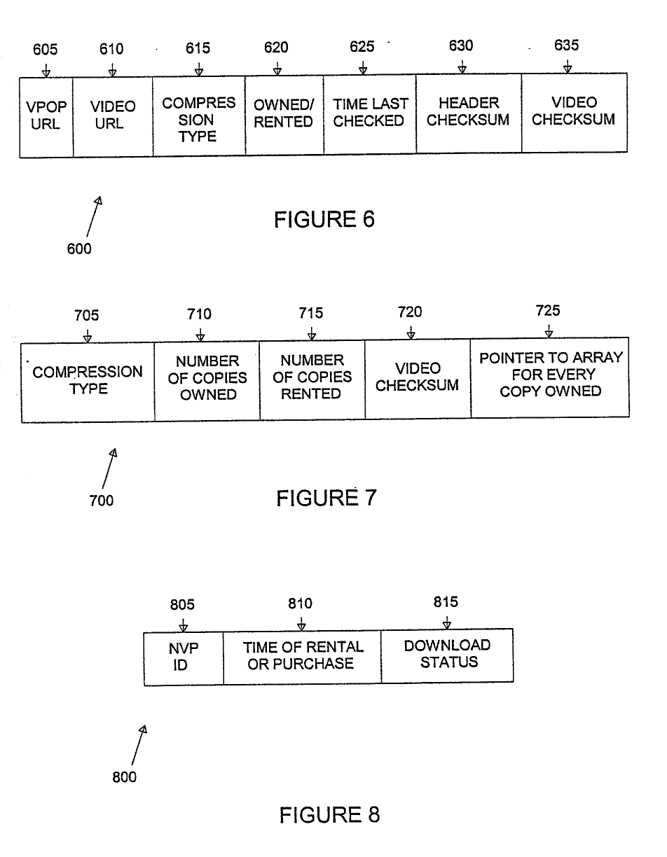

FIG. 6 illustrates exemplary header 600, which may be attached to video files downloaded to NVP 112 according to one embodiment of the present invention. Exemplary header 600 comprises seven data fields. Field 605 in header 600 contains the URL of the VPOP network (e.g., VPOP network 150) that provides the downloaded video file. The VPOP URL in field 605 allows NVP 112 to determine the source of the downloaded video file. The VPOP URL may subsequently used to validate whether the video is still within the rented duration, as well as to extend the rental duration if requested by the subscriber.

Field 610 in header 600 contains the URL of the selected video. The VIDEO URL allows NVP 112 to uniquely identify the video to VPOP network 150 as well as VISP network 180 during the rental, purchase, viewing, and extension transactions. Field 615 in header 600 contains the Compression Type. The Compression Type data tells NVP 112 what algorithm was used to compress the video content. This information is used by NVP 112 to decompress the stored video for viewing.

Field 620 in header 600 contains a data value indicating whether the video was rented or purchased by the subscriber. The Owned/Rented data value is used by NVP 112 to determine if it is necessary to check the rental period validity before playing the video on television 111. Field 625 in header 600 contains a time stamp of the last time the video was played. The Time Last Checked data value is used by NVP 112 to determine if it is necessary to check with VPOP network 150 for rental period validity before playing the video on television 111.

Field 630 in header 600 contains a checksum value for all of the data in header 600. The Header Checksum value is used by NVP 112 to determine whether the header downloaded from VPOP network 150 during video rental transactions was received without errors. Field 635 in header 600 contains a checksum value for all of the video file, excluding header 600. The Video Checksum value is used by NVP 112 to determine whether the video file downloaded from VPOP network 150 was received without errors.

FIG. 7 illustrates exemplary header 700, which may be attached to video files stored on VPOP network 150 according to one embodiment of the present invention. Exemplary header 700 comprises five data fields. Field 705 in header 700 contains the compression type. The Compression Type data identifies the algorithm used to compress the video content. This information is used to decode the video for viewing on NVP 112. Field 710 in header 700 contains the number of copies of the video owned by VPOP network 150. The Number of Copies Owned value determines how many copies of the video may be rented or sold by VPOP network 150.

Field 715 in header 700 contains the number of copies of the video currently rented from VPOP network 150. The Number of Copies Rented value keeps a real-time record of the number of each video file that have been rented to subscribers. Field 720 in header 700 contains a checksum of the actual video content. The Video Checksum value is used during the video download process to ensure that all of the video content is correctly downloaded from VPOP network 150 to NVP 112. Field 725 in header 700 contains a pointer to an array of records, one for each copy of the video rented from VPOP network 150. The records array keeps track of which NVP rented each video and when the video was rented.

FIG. 8 illustrates exemplary header 800, which may be attached to records in VPOP database 236 for each copy of a video rented according to one embodiment of the present invention. Field 805 in header 800 contains the NVP ID of NVP 112, which belongs to the subscriber that rented the video. Field 810 in header 800 contains the time at which the video was rented by NVP 112. Field 815 in header 800 contains a status value indicating whether or not the video has been downloaded by NVP 112 or if a download is still pending.

VPOP network 150 can receive inputs from NVP 112, VISP network 180 or database updates from the local system administrator. Database updates to VPOP network 150 happen when new videos are added to or deleted from VPOP network 150 or if additional copies of an existing video are purchased. The addition of new videos requires VPOP network 150 to send the database updates to VISP network 180 to ensure that VISP network 180 has current information on all VPOPs carrying the newly added video. The database updates for adding more copies of an existing video are local changes and do not have to be sent to VISP network 180.

When VPOP network 150 receives a lock video request from VISP network 180, it checks the Number of Copies Rented field in the video's header. If the Number of Copies Rented is equal to the Number of Copies Owned field, then VPOP network 150 sends a Lock Video Request deny message back to VISP network 180. Otherwise, VPOP network 150 checks whether the Lock Video Request is a rental or purchase transaction. If it is a purchase transaction, VPOP network 150 decrements the Number of Copies Owned field, sets the Download Status field in that copy's header to “Purchase Download Pending” and sends a Lock Video Acknowledge message to VISP network 180. If the Lock Video Request from VISP network 180 is a rental transaction, VPOP network 150 increments the Number of Copies Rented field in the video's header, sets the Download Status field in that copy's header to “Rental Download Pending” and sends a Lock Acknowledge message to VISP network 180. In both rental and purchase transactions, VPOP network 150 updates the NVP ID field in that video copy's header with the NVP ID of NVP 112 requesting the transaction.

When VPOP network 150 receives a download or extension request from NVP 112, VPOP network 150 looks through the array of headers for the video requested to see if the NVP ID exists. If the NVP ID does not exist, VPOP network 150 sends an error message back to NVP 112. If the NVP ID exists and it is an extension request, VPOP network 150 sends a Download Complete message to VISP network 180 (along with NVP ID and VIDEO URL information) and sends a duration extended message to NVP 112. If the NVP ID exists and it is a download request, VPOP network 150 creates a new header for the video to be downloaded to NVP 112. VPOP network 150 fills in the VPOP URL, the VIDEO URL, the Compression Type value, the Owned/Rented value (based on whether the Download Status indicates purchase or rental pending), the Header Checksum value, and the Video Checksum value. The header is downloaded to NVP 112 first, followed by the actual video file.

If the download is successful, VPOP network 150 sends a Download Complete message to VISP network 180, providing the NVP ID, the VPOP URL, and the VIDEO URL. If the download is unsuccessful, VPOP network 150 checks the Download Status field in that video copy's header to see if the video was a rental or a purchase. If the video was a rental, VPOP network 150 decrements the Number of Copies Rented field in the video header. If it was a purchase transaction, VPOP network 150 increments the Number of Copies Owned field in the video header (the above two steps restore the original number of copies owned or rented and cancel out the pending transaction) VPOP network 150 also clears the NVP ID and Download Status fields from that video copy's header. Finally, VPOP network 150 sends a Download Failed message to VISP network 180 and provides the NVP ID and the VIDEO URL.

As introduced hereinabove, those skilled in the art will readily see that the video or other data content may suitably be downloaded in a variety of ways. According to one advantageous embodiment, for the purposes of downloading, the video file may be divided into a plurality of associated data segments. Each data segment is self contained and may be downloaded independently of the others and then used to reconstruct the video content at subscriber site 110. Advantageously, the data segments are sequenced numerically using file name extensions. Segmenting or otherwise breaking up the video files allows NVP 112 to start playing the movie after the first segment is downloaded. The other data segments continue to download while the first segment (and subsequent segments thereafter) continue to play. According to a related advantageous embodiment, individual segment size may be determined based on the slowest download speed to ensure that the next segment will be downloaded before the previous segment finishes playing on NVP 112.

According to yet another related embodiment, the download process may be interrupted because of a failure of VPOP network 150, thereby enabling NVP 112 to choose to continue downloading the segment content from another VPOP network 150 starting from the segment that was interrupted rather than starting the entire download process over again. This enables the subscriber to recover from errors without incurring the prolonged delay that would occur if the video file download were restarted from the beginning.

Besides browsing VISP network 180 web site and requesting video content to be rented or purchased, the subscriber can also select and view videos already downloaded to NVP 112. To select a locally stored video, the subscriber chooses the select option on the remote control or wireless keyboard. At this point, a list of all locally stored videos is displayed on the subscriber's television screen. The subscriber navigates through the list of videos and chooses a video to be viewed. Once a video is selected, the subscriber can apply typical VCR commands like play, fast forward, rewind, pause and stop. The rewind, fast forward, pause and stop commands are completely local (do not require any transactions with VPOP network 150 or VISP network 180). When one of these commands is chosen, NVP 112 performs the appropriate action on the locally stored video.

When the subscriber elects to play locally stored video that the subscriber has selected, NVP 112 checks the Owned/Rented field in the video's header to determine if the video is owned by the subscriber or rented. If the video is owned, then it is played on the subscriber's TV screen. If the video is rented, NVP 112 checks the Time Last Checked value in the video's header to determine the last time the video was played. If the Time Last Checked is within two hours of the current NVP time, then the video is immediately played on the subscriber's TV screen. If the time elapsed since the Time Last Checked value is greater than two hours, then NVP 112 uses the VPOP URL value in the video header to connect to VPOP network 150 from which the video is rented. NVP 112 also provides VPOP network 150 with the NVP ID of NVP 112, as well as the VIDEO URL value stored in the video's header.

NVP 112 waits for VPOP network 150 to determine whether the video is within the video rental duration. If the video is still within the rented duration, NVP 112 updates the Time Last Checked value to the current time and plays the video on the subscriber's TV screen. If the video's rental duration has expired NVP 112 prompts the subscriber to extend the video's rental duration. If the subscriber does not elect to extend the rental duration, NVP 112 deletes the video from local storage. If the subscriber elects to extend the rental duration, NVP 112 connects to VISP network 180 and provides it with the VPOP URL for VPOP network 150, the VIDEO URL, and the NVP ID information. VISP network 180 then displays the user authentication screen on the subscriber's TV screen. The subscriber follows the authentication and payment processes described previously. When authentication is done, NVP 112 connects to VPOP network 150 and provides it with the VIDEO a URL and NVP ID and requests to extend the video rental. After extension confirmation is received from VPOP network 150, NVP 112 updates the Time Last Checked value to the current time and plays the video on television 111.

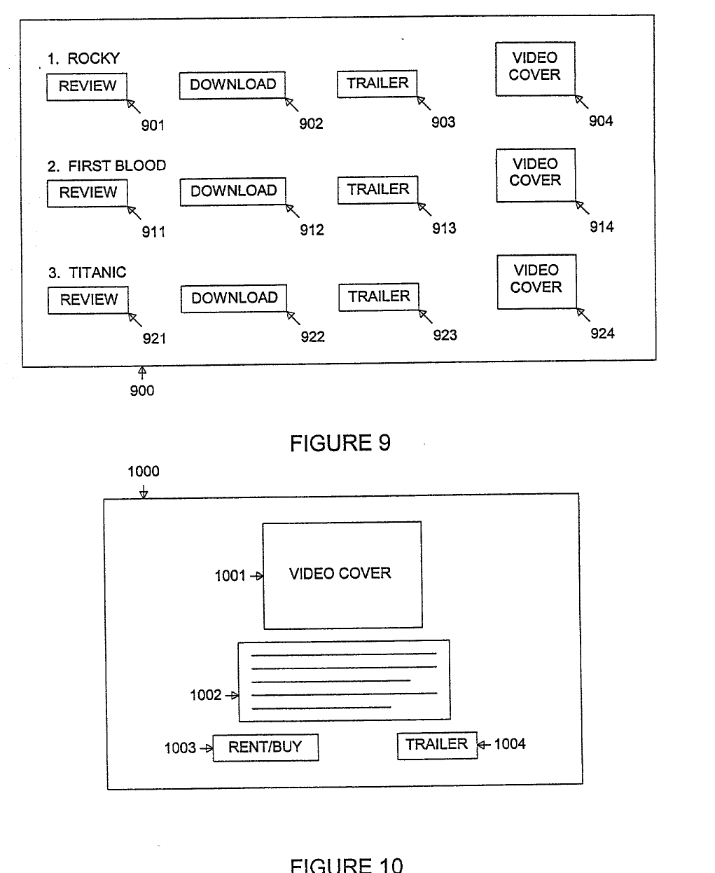

FIG. 9 illustrates exemplary web page 900 from which a subscriber using NVP 112 may select a video to rent or to purchase, according to one embodiment of the present invention. Web page 900 contains listings for three videos, “Rocky,” “First Blood,” and “Titanic,” which the subscriber may rent using NVP 112. Four selectable icons are associated with the “Rocky” video, including review icon 901, download icon 902, trailer icon 903, and video cover icon 904. Similarly, four selectable icons are associated with the “First Blood” video, including review icon 911, download icon 912, trailer icon 913, and video cover icon 914. Finally, four selectable icons are associated with the “Titanic” video, including review icon 921, download icon 922, trailer icon 923, and video cover icon 924. Selecting any one of the review icons transfers the subscriber to web page 1000, explained below in FIG. 10, from which the subscriber may read a review of the corresponding movie. By selecting any one of the download icons, the subscriber may begin the process of downloading the selected video to NVP 112. By selecting any one of the trailer icons, the subscriber may view a brief video clip from the corresponding video file. Selecting any one of the video cover icons transfers the subscriber to web page 1000. In an advantageous embodiment of the present invention, video cover icons 904, 914, and 924 are smaller sized graphic images (typically in JPEG or GIF format) of the box cover of the corresponding video.

FIG. 10 illustrates exemplary web page 1000 from which a subscriber using NVP 112 may learn additional details concerning a selected video, according to one embodiment of the present invention. The subscriber using NVP 112 enters web page 1000 by selecting, for example, one of video cover buttons 904, 914, or 924 in web page 900. Web page 1000 comprises video cover icon 1001, movie review text 1002, selectable rent/buy icon 1003, and selectable trailer icon 1004.

Movie review text 1002 comprises a scrollable window containing text reviews and/or a synopsis of the corresponding video. Selecting trailer icon 1004 allows a subscriber to view a brief video clip from the corresponding video file. Selecting rent/buy icon 1003 leads to subsequent web pages that begin the process of downloading the selected video to NVP 112. In an advantageous embodiment of the present invention, video cover icon 1001 is a larger sized graphic image (typically in JPEG or GIF format) of the box cover of the corresponding video.

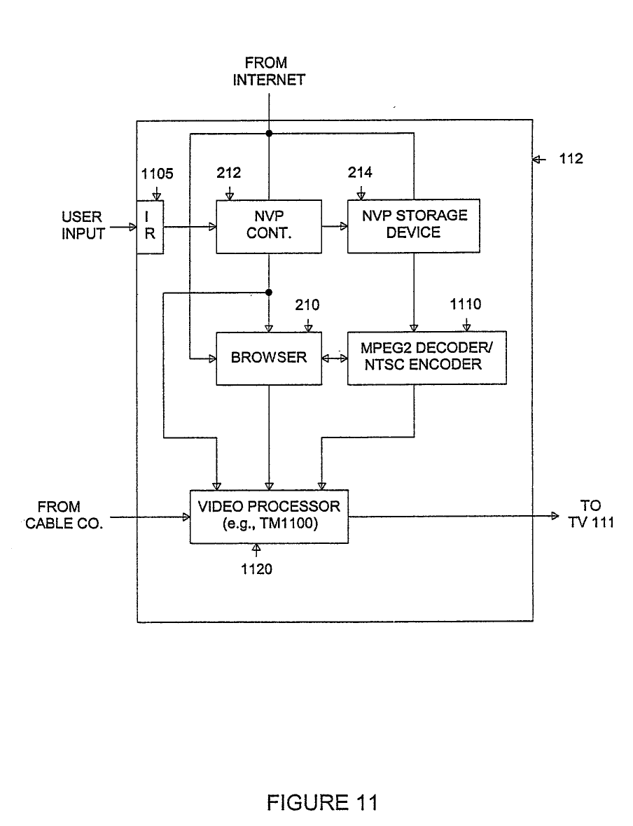

FIG. 11 is a more detailed block diagram of selected portions of exemplary network video player 112 according to one embodiment of the present invention. Network video player (NVP) 112 comprises IR sensor 1105, NVP controller 212, browser 210, NVP storage device 214, MPEG2 decoder/NTSC encoder 1110, and video processor 1120. In the embodiment shown, NVP 112 is implemented as a set-top box that receives television signals from a cable service provider for display of television set 111. However, unlike a conventional cable box, NVP 112 is also capable of browsing the Internet and downloading and renting a video file or other data file. Advantageously, NVP 112 may access the Internet via the cable connection, such as by using a high-speed cable modem service. Alternatively, NVP 112 may use a separate connection, such as a digital subscriber line (DSL), to access the Internet. In other embodiments of the present invention, NVP 112 may receive external television signals from an antenna, rather than from a cable service provider.

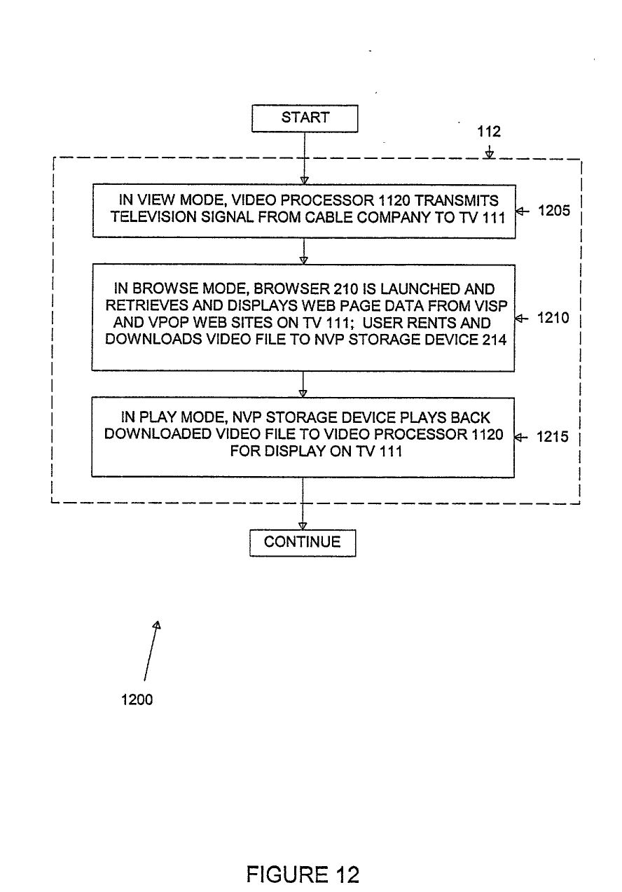

FIG. 12 depicts flow chart 1200, which illustrates the operation of the exemplary network video player 112 according to one embodiment of the present invention. NVP controller 212 directs the overall operation of network video player 112, including View mode, Play mode and Browse mode. In View mode, NVP controller 212 causes the incoming television signal from the cable service provider to be demodulated and processed by video processor 1120 and transmitted to television set 111, without storing or retrieving from NVP storage device 214 (process step 1205). Video processor 1120, which may be, for example, a TriMedia (TM) 1100 media processor, contains radio frequency (RF) front-end circuitry for receiving incoming television signals from the cable service provider, tuning to a user-selected channel, and converting the selected RF signal to a baseband television signal (e.g., super video signal) suitable for display on television set 111. Video processor 1120 also is capable of receiving a conventional NTSC signal from MPEG2 decoder/NTSC encoder 1110 during Play mode and transmitting baseband television signal (e.g., super video signal) to television set 111.

In Browse mode, NVP controller 212 launches browser 210 and directs video processor 1120 to receive its input video signal from browser 210. Once launched, browser 210 receives user commands from, for example, a remote control or an infrared-capable wireless keyboard or mouse. Browser 210 accesses web pages from VISP network 180 and VPOP networks 150, 160, and 170, as explained above, and causes video processor 1120 to display the web pages on television set 111. Video previews, such as MPEG2 video files, received by browser 210 may be transferred to MPEG2 decoder/NTSC encoder 1110 for display in a window on television set 111. Eventually, the user may rent and download a video or other data file. The downloaded video file is stored in NVP storage device 214 for subsequent playback on television set 111 (process step 1210). In Play mode, NVP controller 212 directs NVP storage device 214 to stream a downloaded, rented video file to MPEG2 decoder/NTSC encoder 1110, which converts the MPEG2 data from NVP storage device 214 to, for example, a super video (S-Video) signal that video processor 1120 transmits to television set 111 (process step 1215).

The MPEG2 standard was chosen for MPEG2 encoder 220 and MPEG2 decoder/NTSC encoder 1110 only for the purposes of explaining the invention. In alternate embodiments of the present invention, the MPEG encoder and decoder may comply with the MPEG-1, MPEG-2, MPEG-4 or MPEG-7 standards.

For the purposes of this application and the claims that follow, NVP storage device 214 is defined to include any mass storage device that is both readable and writable, including conventional magnetic disk drives, magnetic tapes for a video cassette recorder (VCR) or video tape recorder (VTR), and optical disk drives for read/write digital versatile disks (DVD-RW), re-writable CD-ROMs, and the like. In fact, NVP storage device 214 need not be fixed in the conventional sense that is permanently embedded in network video player 112. Rather, NVP storage device 214 includes any mass storage device that is dedicated to network video player 112 for the purpose of storing recorded video programs. Thus, NVP storage device 214 may include an attached peripheral drive or removable disk drives (whether embedded or attached), such as a juke box device that holds read/write DVDs or re-writable CD-ROMs. Furthermore, in an advantageous embodiment of the present invention, NVP storage device 214 may include external mass storage devices that network video player 112 may access and control via a network connection (e.g., Internet protocol (IP) connection), including, for example, a disk drive in the user's home personal computer (PC) or a disk drive on a server at the user's Internet service provider (ISP).

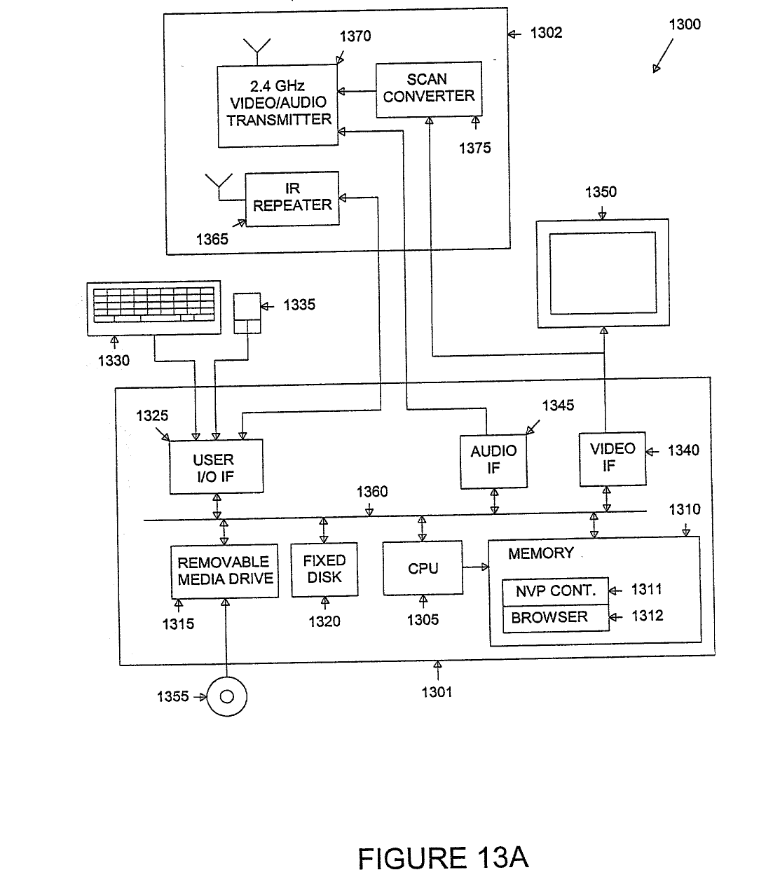

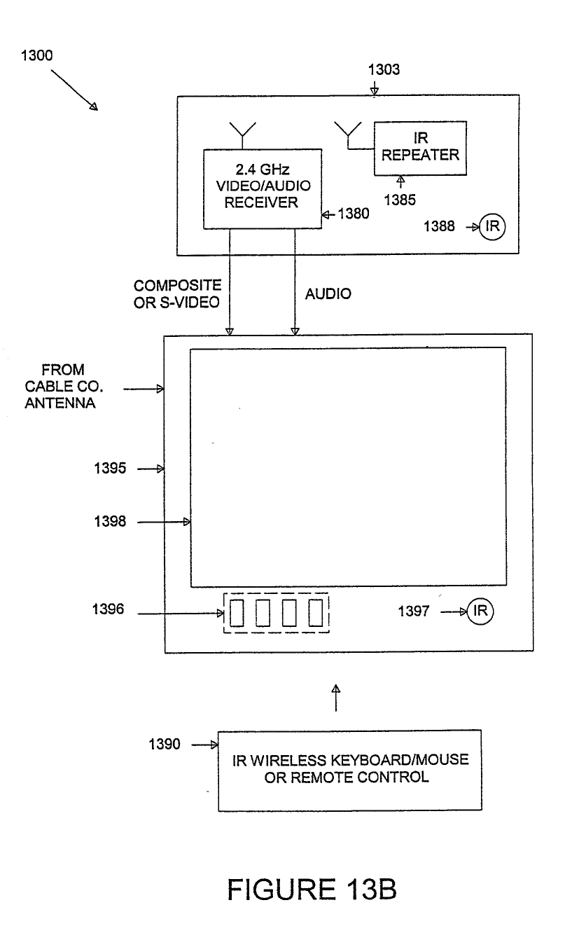

FIGS. 13A and 13B illustrate exemplary PC-based network video player (NVP) 1300 according to an alternate embodiment of the present invention. PC-based NVP 1300 comprises personal computer (PC) 1301, PC communication module 1302 and television (TV) communication module 1303. PC communication module 1302 and TV communication module 1303 provide a two-way communication link that allows PC 1301 to be used as a virtual network video player that operates television (TV) set 1395. This eliminates the need for an actual set-top box coupled to TV set 1395, thereby reducing the equipment required to implement the present invention.

PC 1301 comprises data processor (CPU) 1305, memory 1310, removable media drive 1315, fixed (i.e., “hard”) disk drive 1320, user input/output (I/O) interface (IF) 1325, keyboard 1330, mouse 1335 (or a similar pointing device), video interface (IF) 1340, audio interface (IF) 1345 and monitor 1350. Memory 1310 may comprise volatile memory, such as dynamic random access memory (DRAM), non-volatile memory, such as flash RAM, or a combination of volatile and non-volatile memory. Memory 1310 stores application programs and data executed by CPU 1305, including NVP controller program 1311 and browser program 1312, explained below. Removable media drive 1315 may be any type of storage device that is capable of reading from and/or writing to a removable storage medium, such as a 3.5 inch floppy diskette, a CD-ROM, a writable CD, a digital versatile disk (DVD), or the like. A removable storage medium, such as CD-ROM 1355, may be used to load onto fixed disk drive 1320 application programs and data, including NVP controller program 1311 and browser program 1312.

Keyboard 1330 and mouse 1335 are coupled to PC 1301 via user I/O IF 1325. Monitor 1350 is coupled to PC 1301 via video IF 1340. The internal components of PC 1301, including CPU 1305, memory 1310, removable media drive 1315, fixed disk drive 1320, user I/O IF 1325 video IF 1340 and audio IF 1345 are coupled to, and communicate across, internal communication bus 1360.

PC communication module 1302 comprises IR repeater 1365, 2.4 GHz video-audio transmitter 1370, and scan converter 1375. TV communication module 1303 comprises 2.4 GHz video-audio receiver IR repeater 1385 and infrared (IR) sensor 1388. TV communication module 1303 is coupled to TV 1395. TV set 1395 is a conventional television comprising screen 1398, infrared (IR) sensor 1397, and one or more manual controls 1396 (indicated by a dotted line). IR sensor 1397 receives commands (such as volume up, volume down, power ON/OFF) from a remote control device operated by the viewer.

The viewer's remote control device is represented by viewer device 1390, which may be a conventional remote control that communicates with IR sensors 1388 and 1397, or a wireless keyboard and/or mouse that communicates with IR sensors 1388 and 1397. IR repeaters 1365 and 1385 are wireless transceivers that relay user commands bi-directionally between PC communication module 1302 and TV communication module 1303. Commands entered by the user on viewer device 1390 are detected by IF sensor 1388 and transmitted to PC communication module 1302 via IR repeaters 1365 and 1385. Similarly, commands entered by the user on keyboard 1330 or mouse 1335 are transmitted to TV communication module 1303 via user I/O IF 1325 and IR repeaters 1365 and 1385. In an advantageous embodiment of the present invention, keyboard 1330 and mouse 1335 may be wireless devices that communicate with user I/O IF 1325 via an infrared link or RF link.

The monitor output from PC 1301 is connected simultaneously to monitor 1350 and PC communication module 1302 through a standard VGA splitter cable. Scan converter 1375 in PC communication module 1302 converts the VGA output from PC 1301 into an NTSC or PAL TV signal. An analog signal protection scheme (such as the APS offered by Macrovision™) can be included in scan converter 1375 to ensure that the video output cannot be recorded by a VCR unless the viewer is authorized to do so. The analog protection can be turned on or off by NVP controller program 1311 based on what video program is being outputted from PC 1301. This control can be established through a serial port on PC 1301 connected to 2.4 GHz video-audio transmitter 1370.

The NTSC or PAL output from scan converter 1375 is sent to 2.4 GHz video-audio transmitter 1370, which can broadcast the video signal to 2.4 GHz video-audio receiver. This transmission is possible through walls, ceilings, and the like, so that TV 1395 can be virtually located in any room in the house and away from PC 1301. In an exemplary embodiment, a standard IR receiver (such as ones used in wireless keyboard/mouse devices) may be attached to the keyboard and mouse ports of PC 1301. Likewise, the audio (i.e., speaker) output from PC 1301 is sent to 2.4 GHz video-audio transmitter 1370 and then broadcast to 2.4 GHz video/audio receiver.

In the living room, TV communication module 1303 is coupled to (e.g., placed on top of) TV 1395. 2.4 GHz video/audio receiver 180 receives the audio and video signals transmitted by 2.4 GHz video-audio transmitter 1370 and outputs the video signal as, for example, a composite video signal or a super-video (S-video) signal. The video and audio outputs are connected to the audio/video input connections on TV set 1395 in the same manner as a video cassette recorder would be connected.

IR repeater 1385 in TV communication module 1303 converts the IR output from viewer device 1390 to a radio frequency (RF) and broadcasts it through walls, ceilings, and the like, to IR repeater 1365. IR repeater 1365 converts the RF signal back to standard keyboard/mouse commands that are transferred to user I/O IF 1325. If user I/O IF 1325 is an IR sensor that receives IR signals from IR-equipped keyboard 1330 and mouse 1335, then IR repeater 1365 converts the RF signal back to IR commands that re received by user I/O IF 1325. The user has full control of PC 1301 through viewer device 1390 located in, for example, the living room. Thus, the present invention uses relatively inexpensive wireless video transmitter/receiver units (about one third or less of the cost of a set-top box) to provide the user with all the benefits of an advanced broadband set-top box.

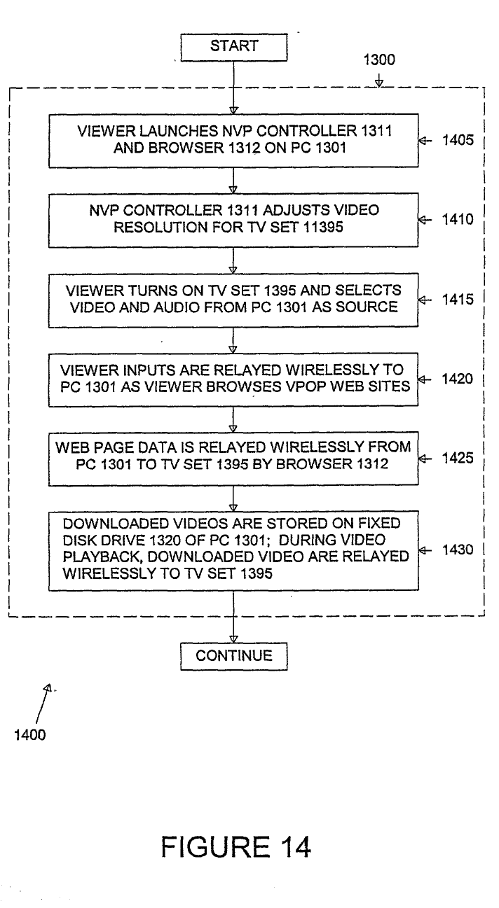

FIG. 14 depicts flow diagram 1400, which illustrates the operation of exemplary PC-based network video player 1300 according to an alternate embodiment of the present invention. To set up the present invention for operation, the user/viewer clicks an icon on the Windows desktop on monitor 1350. This action launches NVP controller program 1311 and browser 1312 on PC 1301 (process step 1405). NVP controller program 1311 automatically adjusts the VGA resolution to suit viewing on TV set 1395, rather than monitor 1350 (process step 1410). This single action is all that is required by the user/viewer before moving to his or her living room and accessing the features of PC-based network video player 1300 from TV set 1395. The viewer turns on TV set 1395 and selects the video input to which the video and audio outputs of TV communication module 1303 are connected (process step 1415). At this point, the viewer may see a web page from VISP web site 220.

Thereafter, the user may browse various VPOP web sites, such as VPOP web site 230, in order to rent and download a video file or other data file. The navigation commands and alphanumeric characters entered by the viewer on viewer device 1390 are wirelessly relayed via IR repeaters 1385 and 1365 to PC 1301 (process step 1420). NVP controller program 1311 and browser 1312 continue to operate as tasks on PC 1301 and receive the navigation commands and alphanumeric characters entered by the viewer. In response to the viewer's inputs, browser 1312 transmits web page data from VISP web site 220 and the various VPOP web sites associated with VPOP networks 150, 160, 170 to TV set 1395 via 2.4 GHz video-audio transmitter 1370 and 2.4 GHz video-audio receiver 1380 (process step 1425). Downloaded videos may then be stored in PC 1301 on fixed disk 1320 or on a writable storage medium inserted in removable media drive 1315. During playback, rented videos are retrieved from fixed disk 1320 or the writable storage medium, are converted to conventional video signals by CPU 1305 and/or video IF 1340, and are transmitted to TV set 1395 via 2.4 GHz video-audio transmitter 1370 and 2.4 GHz video-audio receiver 1380 (process step 1430).

Additionally, the viewer may access other functions using PC-based network video player 1300, including e-mail, ordinary web browsing, video e-mail (i.e., 2.4 GHz wireless video camera allows user to record and send video e-mail messages), viewer account information (i.e., user accesses his/her video rental account to see what movies were rented, balance, etc.).

Although the present invention has been described in detail, those skilled in the art should understand that they can make various changes, substitutions and alterations herein without departing from the spirit and scope of the invention in its broadest form.

What is claimed is:

1. For use in connection with a communication network capable of communicating with a plurality of video content servers storing a plurality of video files for download to a subscriber, an apparatus for downloading a first selected one of said plurality of video files comprising:
a processing system comprising a central processing unit (CPU) and a memory capable of executing a browser program and a video download control program; and
a wireless transceiver system capable of being coupled to said processing system and capable of transmitting video outputs and audio outputs generated by said browser program and said video download control program to a television set apart from said processing system and further capable of receiving user commands and user data transmitted by a viewer control device operated by a viewer of said television set, wherein said received user commands and user data are used by said browser program and said video download control program to browse said plurality of video content servers and to download said first selected video file.

2. The apparatus as set forth in claim 1 wherein said browser program is capable of accessing said video content servers and retrieving therefrom web page data associated with said plurality of video files and displaying said web page data on said television set.

3. The apparatus as set forth in claim 2 wherein said video download control program, in response to a first user command from said viewer requesting a first selected one of said plurality of video files, downloads said first selected video file from a first one of said plurality of video content servers.

4. The apparatus as set forth in claim 3 wherein said processing system further comprises a mass storage medium capable of storing said downloaded first selected video file.

5. The apparatus as set forth in claim 4 wherein said browser program is capable of displaying on said television a plurality of video selection menus associated with said web page data, a first one of said video selection menus containing a first menu option associated with said first selected video file, wherein said video download control program is further capable of receiving from said viewer a first video selection command selecting said first selected video file to be downloaded.

6. The apparatus as set forth in claim 5 wherein said video download control program, in response to receipt of said first video selection message, transmits to said first video content server a video request message comprising a subscriber identifier associated with said video download control program, said video request message capable of causing said first video content server to transmit said first selected video file to said processing system when said video download control program subsequently transmits said subscriber identifier to said first video content server.

7. The apparatus as set forth in claim 6 wherein said video request message further comprises a video identifier associated with said first selected video file, wherein said first video content server uses said video identifier to select said first selected video file from said plurality of video files for transmission to said processing system.

8. For use in connection with a communication network capable of communicating with a plurality of video content servers storing a plurality of video files for download to a subscriber, an apparatus for downloading a first selected one of said plurality of video files comprising:
a wireless transceiver system capable of being coupled to a television set and capable of receiving video outputs and audio outputs transmitted by a processing system apart from said television set and displaying said received video outputs and audio outputs on said television set, wherein said wireless transceiver system is further capable of receiving user commands and user data transmitted by a viewer control device operated by a viewer of said television set and transmitting said received user commands and user data to said processing system, wherein said received user commands and user data are usable by a browser program and a video download control program executed by said processing system to browse said plurality of video content servers and to download said first selected video file.

9. The apparatus as set forth in claim 8 wherein said browser program is capable of accessing said video content servers and retrieving therefrom web page data associated with said plurality of video files and displaying said web page data on said television set.

10. The apparatus as set forth in claim 9 wherein said video download control program, in response to a first user command from said viewer requesting a first selected one of said plurality of video files, downloads said first selected video file from a first one of said plurality of video content servers to a mass storage medium associated with said processing system.

11. The apparatus as set forth in claim 10 wherein said browser program transmits to said wireless transceiver system a plurality of video selection menus associated with said web page data, a first one of said video selection menus containing a first menu option associated with said first selected video file, wherein said video download control program is further capable of receiving from said wireless transceiver system a first video selection command selecting said first selected video file to be downloaded.

12. The apparatus as set forth in claim 11 wherein said video download control program, in response to receipt of said first video selection message, transmits to said first video content server a video request message comprising a subscriber identifier associated with said video download control program, said video request message capable of causing said first video content server to transmit said first selected video file to said processing system when said video download control program subsequently transmits said subscriber identifier to said first video content server.

13. The apparatus as set forth in claim 12 wherein said video request message further comprises a video identifier associated with said first selected video file, wherein said first video content server uses said video identifier to select said first selected video file from said plurality of video files for transmission to said processing system.

14. For use in connection with a communication network capable of communicating with a plurality of video content servers storing a plurality of video files for download to a subscriber, a network video player for downloading a first selected one of said plurality of video files comprising:
a browser program stored on a computer-readable storage medium capable of being executed by a processing system comprising a central processing unit (CPU) and a memory; and
a video download control program stored on said computer-readable storage medium capable of being executed by said processing system,
wherein said browser program and said video download control program are capable of transmitting video outputs and audio outputs generated by said browser program and said video download control program to a television set via a wireless transceiver system coupled to said processing system and are further capable of receiving via said wireless transceiver system user commands and user data transmitted by a viewer control device operated by a viewer of said television set, wherein said received user commands and user data are used by said browser program and said video download control program to browse said plurality of video content servers and to download said first selected video file.

15. The network video player as set forth in claim 14 wherein said browser program is capable of accessing said video content servers and retrieving therefrom web page data associated with said plurality of video files and displaying said web page data on said television set.

16. The network video player as set forth in claim 15 wherein said video download control program, in response to a first user command from said viewer requesting a first selected one of said plurality of video files, downloads said first selected video file from a first one of said plurality of video content servers.

17. The network video player as set forth in claim 16 wherein said processing system further comprises a mass storage medium capable of storing said downloaded first selected video file.

18. The network video player as set forth in claim 17 wherein said browser program is capable of displaying on said television a plurality of video selection menus associated with said web page data, a first one of said video selection menus containing a first menu option associated with said first selected video file, wherein said video download control program is further capable of receiving from said viewer a first video selection command selecting said first selected video file to be downloaded.

19. The network video player as set forth in claim 18 wherein said video download control program, in response to receipt of said first video selection message, transmits to said first video content server a video request message comprising a subscriber identifier associated with said video download control program, said video request message capable of causing said first video content server to transmit said first selected video file to said processing system when said video download control program subsequently transmits said subscriber identifier to said first video content server.

20. The network video player as set forth in claim 19 wherein said video request message further comprises a video identifier associated with said first selected video file, wherein said first video content server uses said video identifier to select said first selected video file from said plurality of video files for transmission to said processing system.
